(19) United States
(12) Patent Application Publication
(10) Pub. No.: US 2021/0206262 A1
(43) Pub. Date: Jul. 8, 2021

(54) BANK ANGLE SENSOR WITH FAILSAFE SYSTEM

(71) Applicant: PADMINI VNA MECHATRONICS PVT. LTD., GURGAON (IN)

(72) Inventors: KABIR BHANDARI, NEW DELHI (IN); AMARDIP KUMAR, GURGAON (IN); KUMAR ABHISHEK, Gurgaon (IN); SUDHIR PATTNAIK, Gurgaon (IN)

(21) Appl. No.: 17/059,487

(22) PCT Filed: May 29, 2019
(86) PCT No.: PCT/IB2019/054436

§ 371 Date: Nov. 30, 2020

(30) Foreign Application Priority Data
May 29, 2018 (IN) 201811020084

(51) Int. Cl. B60K 28/14; G01B 7/30

(52) U.S. Cl. CPC B60K 28/14; G01B 7/30

(57) ABSTRACT

The present invention provides a bank angle sensor for motor vehicles. More specifically, the invention provides a bank angle sensor with inbuilt hall sensor and mechanical failsafe mechanism to switch off the engine if the vehicle inclines from a prescribed limit and tends to tip over.

### FIELD OF THE INVENTION

The present invention provides a failsafe bank angle sensor assembly for a vehicle engine. More specifically, the invention provides failsafe bank angle sensor assembly to switch off the engine and fuel vapor supply if the vehicle inclines from a prescribed limit and tends to tip over.

### BACKGROUND OF THE INVENTION

In many cases it is desired to estimate real time tilt and/or incline angle of a vehicle body such as a motorcycle. For example, in case where estimate values of the tilt and/or incline angle of a vehicle body are required for traction control of a driving wheel of a motorcycle. It is required to be known so that if a vehicle inclines from a prescribed limit and tends to tip over, action can be taken to avoid any big mis-happening or accident.

Motorcycles generally require operation at a lean angle relative to vertical; the lean angle is used to assist in turning. Motorcycles occasionally tip over (e.g., are leaned too far) during operation. When a motorcycle is laid on its side when running, fuel can spill from the fuel supply system and the laid-down orientation of the motorcycle can otherwise adversely affect engine operation. Additionally, motorcycles can tip over if the lean angle exceeds a certain angle at which the center of gravity is out of a controllable range. Under this condition, the system is also desired to deactivate the fuel supply. To avoid any accident during this time bank angle sensors are provided in a motorcycle which switches off the engine if the vehicle inclines from a prescribed limit and tends to tip over.

In U.S. Pat. No. 6,941,206 B2, a tip over detection device is disclosed that uses a vertically oriented sensor to improve the accuracy of detecting when the vehicle has tipped over. An ECU communicates with the accelerometer and controls engine operation. The ECU stops the engine, preferably gradually, when the vehicle has tipped over. In state of the art, there is no provision which can detect the false alarm as well as there is no provision of any additional safety mechanism in case sensor fails.

In CN101758776B, a vehicle tilt sensing means is disclosed comprising a primary sensor, a comparator circuit and a switching circuit, wherein the sensor senses that the vehicle body inclination state and emits a sensing signal; said comparator circuit according to the sensing signal of the sensor is determined delivered whether the vehicle body inclination angle is greater than the threshold value, further transmission control signal; said switch circuit receives the control signal transmitted by the comparison circuit and the signal controlling the operation of the engine. In state of the art, to control the operation of engine there are plurality of sensors and modules which leads to dependency as well as add ups to the overall cost to the buyer.

Accordingly, a system is desired that will deactivate the fuel supply system and possibly the engine during such tipping. Therefore, as we can deduce from the state of art that a bank angle sensor is required, while focusing towards eliminating the plurality of components to promote a simple and favorable design yet maintaining its working performance and efficiency which results in reducing manufacturing cost. As well as a bank angle sensor with additional safety mechanism is required that can operate even if the primary sensor fails to operate in any condition.

### OBJECT OF THE INVENTION

The main object of the invention is to provide a failsafe bank angle sensor assembly to switch off the engine and cut-off the fuel vapor supply if the vehicle inclines from a prescribed limit and tends to tip over.

Yet another object of the invention is to provide an incorporation of a hall sensor within the housing of a failsafe bank angle sensor assembly to switch off the engine if the vehicle reclines from a prescribed limit.

Yet another object of the invention is to customize a failsafe bank angle sensor assembly to give a feedback signal using the built-in hall sensor to switch off the engine if the vehicle inclines from a prescribed limit and tends to tip over.

Still another object of the invention is to provide a robust and effective failsafe bank angle sensor assembly having a magnetic moving core in its housing to safely cut-off the fuel vapor supply by sealing the inlet port.

### SUMMARY OF THE INVENTION

The present invention provides a failsafe bank angle sensor assembly for a vehicle engine. More specifically, the invention provides the failsafe bank angle sensor assembly to switch off the engine and cut-off the fuel vapor supply if the vehicle inclines from a prescribed limit and tends to tip over.

In an embodiment of the present invention, the failsafe bank angle sensor assembly includes an inlet port for fuel vapor transfer, a sealing body, a magnetic core, plurality of compression springs, a molded housing with built-in hall sensor, a cushioning tip and an outlet port for fuel vapor transfer.

In another embodiment of the present invention, the failsafe bank angle sensor assembly is provided having an arrangement wherein, the inlet port and outlet port are provided for establishing a fuel channel for fuel vapor transfer. Both ports are molded and made up of material such as, but not limited to thermoplastic, poly carbonate, poly propylene, etc. Further, a molded housing is made up of material such as, but not limited to thermoplastics, PVC, PUC, etc. with built-in hall sensor is provided which provides a feedback signal to switch off the engine, if the vehicle inclines from a prescribed limit and tends to tip over. Molded housing has provision to assemble a sealing body made up of material such as, but not limited to like copper, brass etc. with a cushioning tip made up of material such as, but not limited to like Teflon, PU, etc. attached to it using a compression spring. A magnetic core is also assembled within the inner diameter of molded housing along with a compression spring which is serving as sensor magnet for built-in hall sensor. The hall sensor detects the moving of magnetic core as it moves through stroke length and provides feedback in terms of output voltage respective to its position which further gives signals to switch off the engine. Further, at the proximal end of the assembled housing, inlet port is inserted and at distal end, outlet port is inserted. Both inlet port and outlet port are fixed to housing by means of method such as, but not limited to ultrasonic welding, etc. to ensure no leakage from the mating faces and thus complete the assembly of failsafe bank angle sensor.

Therefore, the failsafe bank angle sensor assembly is provided with a built-in hall sensor in its housing which gives feedback signal to switch off the engine if the vehicle inclines from a prescribed limit and tends to tip over. Further, the assembly is provided by magnetic core in its housing which cut-off the fuel vapor supply by sealing the input port if the vehicle inclines from a prescribed limit and tends to tip over due to its own weight.

The arrangement of failsafe bank angle sensor assembly smartly detects the failure in case of magnetic core getting stuck. Also, the arrangement of failsafe bank angle sensor assembly gives add-on feature of getting real time status without any external sensor.

### BRIEF DESCRIPTION OF THE DRAWINGS

The object of the invention may be understood in more details and more particularly description of the invention briefly summarized above by reference to certain embodiments thereof which are illustrated in the appended drawings, which drawings form a part of this specification. It is to be noted, however, that the appended drawings illustrate preferred embodiments of the invention and are therefore not to be considered limiting of its scope, for the invention may admit to other equally effective equivalent embodiments.

FIG. 1 shows the perspective view of a failsafe bank angle sensor assembly in accordance with an embodiment of the present invention.

FIG. 2 shows the position of the failsafe bank angle sensor assembly in accordance with an embodiment of the present invention.

FIG. 3 shows the hall sensor in OFF condition in accordance with an embodiment of the present invention.

FIG. 4 shows the hall sensor in ON condition in accordance with an embodiment of the present invention.

FIG. 5 shows the moving core in OFF condition in accordance with an embodiment of the present invention.

FIG. 6 shows the moving core in ON condition in accordance with an embodiment of the present invention.

### DETAILED DESCRIPTION OF THE INVENTION

The present invention will now be described more fully hereinafter with reference to the accompanying drawings in which a preferred embodiment of the invention is shown. This invention may, however, be embodied in many different forms and should not be construed as being limited to the embodiment set forth herein. Rather, the embodiment is provided so that this disclosure will be thorough, and will fully convey the scope of the invention to those skilled in the art.

With reference to the figures, numerical designation has been given for each element to facilitate the reader's understanding of the present invention, and particularly with reference to the embodiments of the present invention illustrated in the figures. The enclosed description and drawings are merely illustrative of preferred embodiments. Although specific components, materials, configurations and uses of the present invention are illustrated and set forth in this disclosure, it should be understood that a number of variations to the components and to the configuration of those components described herein and in the accompanying figures can be made without changing the scope and function of the invention set forth herein.

In one embodiment, present invention provides a failsafe bank angle sensor assembly for a vehicle engine. More specifically, the invention provides the failsafe bank angle sensor assembly with a built-in hall sensor in its housing for switching off the engine and the magnetic core in its housing to cut-off the fuel vapor supply by sealing an input port if the vehicle inclines from a prescribed limit and tends to tip over.

In a most preferred embodiment, the failsafe bank angle sensor assembly is provided with a built-in hall sensor and a moving core in its housing for a motor vehicle comprising of: an input port, a sealing body, a cushioning tip, a magnetic core, a plurality of compression springs, a molded housing, a hall sensor, and an outlet port; wherein, the magnetic core has the input port, one of the compression spring, the sealing body and the cushioning tip at the proximal end and another compression spring, and the outlet port at the distal end, and the hall sensor is fixed on the side of the magnetic core; the inlet port receives the fuel vapor as the cushioning tip is pushed due to compression of the compression springs while the vehicle is in running condition; the magnetic core changes its position when pushed by one of the compression spring upon vehicle tipping over and reaches to a prescribed limit, the hall sensor detects the change of position of magnetic core and gives a feedback signal to vehicle engine to turn off and stop the fuel vapor supply by closing the inlet port by the cushioning tip due to the push of the compression springs.

In an exemplary embodiment, the failsafe bank angle sensor assembly is provided with a built in hall sensor and a moving magnetic core in its housing. The failsafe bank angle sensor assembly is incorporated in a secondary connection between the fuel tank and the engine of the vehicle. The secondary connection has components that help in control of fuel vapor emission such as but not limited to a purge valve, a two-way valve, a canister and vehicle carburettor connected via a plurality of connectors. The hall sensor senses the position of vehicle at an angle of or greater than the prescribed limit from the vertical. The position of the vehicle depends on the position of the moving magnetic core of bank angle sensor assembly. The vehicle when tilts at an angle equal or greater than the prescribed limit, the moving magnetic core inside the housing changes its position and cut off the fuel vapor supply by sealing the inlet port of the failsafe bank angle sensor assembly. The change in the position of moving magnetic core changes the magnetic field which is sensed by the hall sensor. The hall sensor senses and provides the feedback signal in the form of an electrical voltage to switch off the engine.

The failsafe is defined as the ability of the bank angle sensor assembly to switch off the fuel vapor supply and engine when vehicle inclines at a prescribed limit and when the vehicle tips over. The prescribed limit is preferably 80 degree.

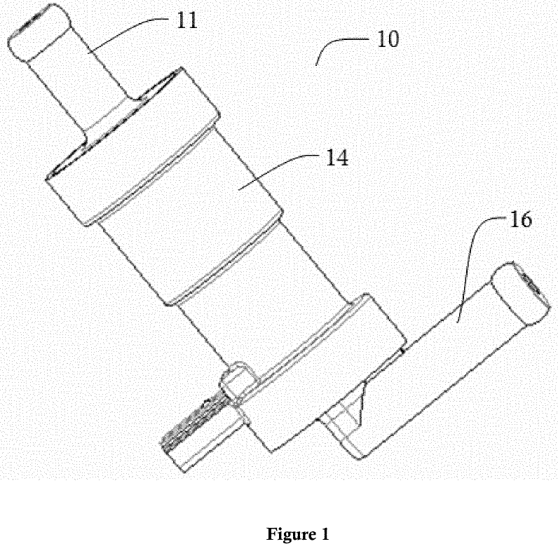

As depicted in FIG. 1, a perspective view of a failsafe bank angle sensor assembly 10 is given. The failsafe bank angle sensor assembly has an inlet port 11, a molded housing 14 and an outlet port 16 forming the outer assembly. The inlet port 11 and the outlet port 16 of the failsafe bank angle sensor assembly form a fuel channel for fuel vapor transfer and are molded parts made up of material such as, but not limited to thermoplastic, poly carbonate, poly propylene, etc. Further, the molded housing 14 is made up of material such as, but not limited to thermoplastics, PVC, PUC, etc. At the proximal end of the molded housing 14, the inlet port 11 is inserted and at the distal end, the outlet port 16 is inserted. Both inlet port 11 and outlet port 11 are fixed to the molded housing 14 by means of method such as, but not limited to ultrasonic welding, etc. to ensure no leakage from the mating faces and thus complete the assembly of bank angle sensor 10.

In a preferred embodiment, the failsafe bank angle sensor assembly 10 comprises of: an input port 11, a sealing body 12, a cushioning tip 19, a magnetic core 13, a plurality of compression springs 17 and 18, a molded housing 14 with a built-in hall sensor 15 and an outlet port 16. The inlet port 11 and outlet port 16 is provided for establishing a fuel channel for fuel vapor transfer. Further, the molded housing 14 with a built-in hall sensor 15 is provided which provides feedback signal to switch off the engine if the vehicle inclines from a prescribed limit and tends to tip over. Molded housing 14 has provision to assemble a sealing body 12 made up of material such as, but not limited to like copper, brass etc. with a cushioning tip 19 made up of material such as, but not limited to like Teflon, PU, etc. is attached to it using a compression spring 17. A moving magnetic core 13 is also assembled within the inner diameter of molded housing 14 along with a compression spring 18 which is serving as sensor magnet for built in hall sensor 15. The hall sensor 15 detects the moving of magnetic core 13 as it moves through stroke length and provides feedback in terms of output voltage respective to its position which further gives signals to switch off the engine.

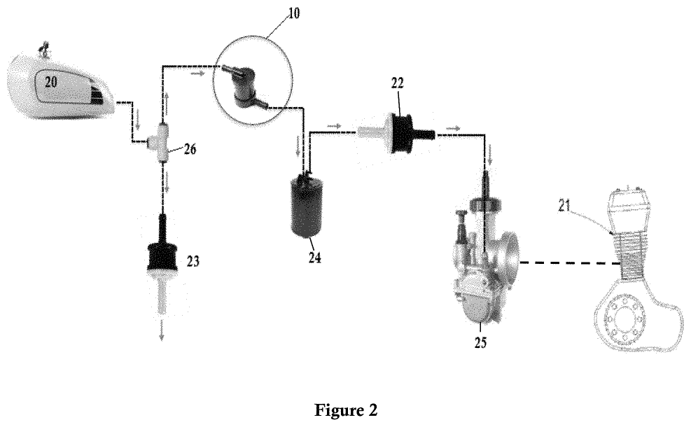

FIG. 2 shows the position of failsafe bank angle sensor assembly inside the motor vehicle in accordance to an embodiment of the present invention. The failsafe bank angle sensor assembly 10 is positioned is incorporated in a secondary connection between the fuel tank 20 and the engine 21 of the vehicle. The secondary connection has components that help in control of fuel vapor emission such as but not limited to a purge valve 22, a two way valve 23, a canister 24 and vehicle carburettor 25 connected via plurality of connectors 26. The inlet of the failsafe bank angle sensor assembly 10 is connected to the fuel tank 20 via a connector 26 and the outlet of the failsafe bank angle sensor assembly 10 is connected to a canister 24 which is further connected to a purge valve 22 which is connected to the engine 21 through a carburettor 25 thus providing a path between the failsafe bank angle sensor assembly 10, engine 21 and fuel tank 20. In the secondary connection one end of the two way valve opens in the atmosphere.

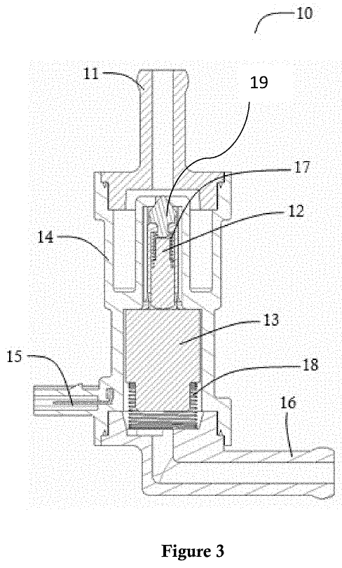

FIG. 3 shows the hall sensor 15, in OFF condition wherein moving magnetic core 13 pushes the sealing body 12 using force of compression spring 18 to the inlet port 11 which obstructs the flow of fluid through housing 14 to the outlet port 16. In such case, since the hall sensor 15 is unable to sense the magnetic field of the moving magnetic core 13 thus the engine remains OFF.

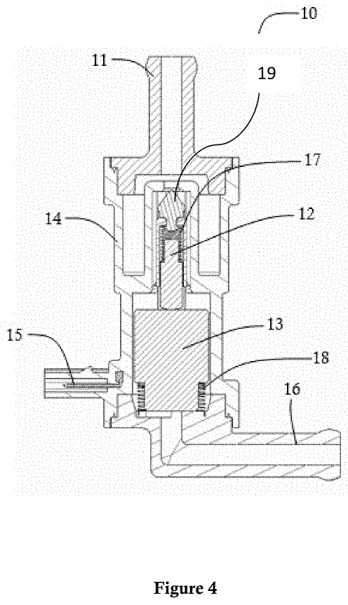

FIG. 4 shows the hall sensor 15, in ON condition wherein moving magnetic core 13 is pulled back as the fluid pressure is applied on the sealing body 12 compressing the compression spring 17 as well as compression spring 18 and the sealing body 12 does not seal the inlet port 11 and allow the flow of fluid to pass through housing 14 to the outlet port 16. In such case, since the hall sensor 15 is able to sense the magnetic field of the movable magnetic core 13 thus the engine remains ON.

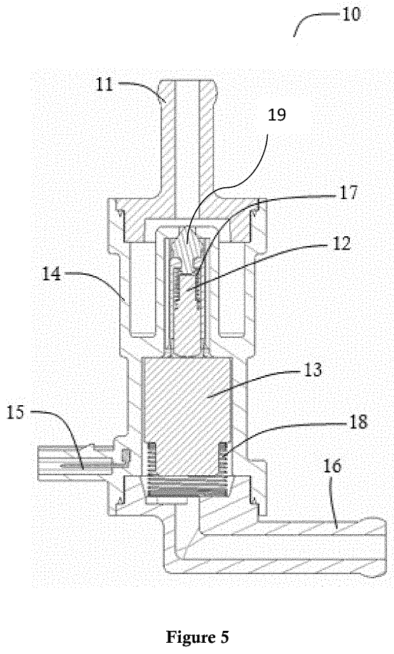

FIG. 5 shows the moving core 13, in OFF condition wherein as soon as the vehicle turns upside down, the flow of the fuel vapor from inlet port 11 is stopped due to sealing of input path 11 by sealing body 12. Sealing is done due to the weight of the magnetic core 13 and the force exerted on it by compression spring 18.

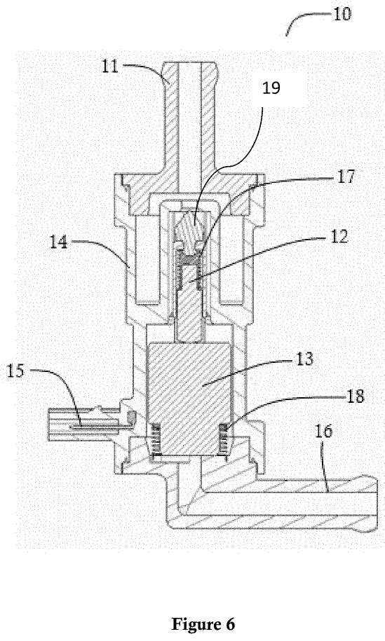

FIG. 6 shows the moving core 13, ON condition wherein the moving magnetic core 13 is in normal rest position which allows fuel vapor to flow through the inlet port 11 to the outlet port 16 through housing 14.

In another embodiment, the failsafe bank angle sensor assembly 10 is provided with built in hall sensor 15 in its housing which gives feedback signal to switch off the engine if the vehicle inclines from a prescribed limit preferably 80 degree and tends to tip over.

In another embodiment, the failsafe bank angle sensor assembly 10 is provided by moving magnetic core 13 in its housing which seals the input port 11 if the vehicle inclines from a prescribed limit preferably 80 degree and tends to tip over due to its own weight.

The arrangement of failsafe bank angle sensor assembly smartly detects the failure in case of magnetic core getting stuck. Also, the arrangement of failsafe bank angle sensor assembly gives add-on feature of getting real time status without any external sensor.

The foregoing description of embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principals of the invention and its practical application to enable one skilled in the art to utilize the invention in various embodiments and with various modifications as are suited to the particular use contemplated.

We claim:

1. A failsafe bank angle sensor assembly (10) for a motor vehicle comprising of:
an input port (11), a sealing body (12), a cushioning tip (19), a magnetic moving core (13), plurality of compression springs (17, 18), a molded housing (14), hall sensor (15), and an outlet port (16);
wherein,
the magnetic moving core (13) has the input port (11), the compression spring (17), the sealing body (12) and the cushioning tip (19) at the proximal end and the compression spring (18), and the outlet port (16) at the distal end;
the hall sensor (15) is fixed at a side inside the molded housing (14) near the magnetic moving core (13);
the inlet port (11) receives the fuel as the cushioning tip (19) is pushed due to compression of the compression springs (17, 18) while the vehicle is in running condition;
the magnetic moving core (13) changes its position when pushed by the compression spring (18) while the vehicle is tipping over and reaches to a prescribed limit, the hall sensor (15) detects the change of position of magnetic moving core (13) and gives a feedback signal to vehicle engine to turn off and stop the fuel vapor supply by sealing the inlet port (11) by the cushioning tip (19) due to the push of the compression springs (17, 18).

2. The sensor assembly (10) as claimed as in claim 1, wherein the feedback signal is in the form of voltage.

3. The sensor assembly (10) as claimed as in claim 1, wherein the prescribed limit is defined as the angle above which the vehicle tends to tip over and said prescribed limit is preferably 80 degree.

4. The sensor assembly (10) as claimed as in claim 1, wherein when the hall sensor (15) in OFF condition, the magnetic moving core (13) pushes the sealing body (12) by the force of compression spring (18) to the inlet port (11) and obstructs the flow of fuel vapor through molded housing (14) to the outlet port (16).

5. The sensor assembly (10) as claimed in claim 1, wherein when the hall sensor (15) in ON condition, the magnetic moving core (13) is pulled back as the fluid pressure applied on the sealing body (12) compress the compression spring (17, 18) and the sealing body (12) does not seal the inlet port (11) and allow the flow of fuel vapor through molded housing (14) to the outlet port (16).

6. The sensor assembly (10) as claimed in claim 1, wherein when the vehicle turns upside down, the flow of fuel vapor from the inlet port (11) is stopped due to weight of the magnetic moving core (13) and the force exerted on it by compression spring (18) sealing the inlet port (11) by sealing body (12).

7. The sensor assembly (10) as claimed in claim 1, wherein when the magnetic moving core (13) is in normal rest position, it allows flow of fuel through the inlet port (11) to the outlet port (16) through housing (14).

8. The sensor assembly (10) as claimed in claim 1, wherein the cushioning tip (19) is made of material including but not limited to Teflon and PU.

9. The sensor assembly (10) as claimed in claim 1, wherein the failsafe is defined as the ability of the sensor assembly (10) to switch off the fuel vapor supply and engine when vehicle inclines at a prescribed limit and tips over.
